(19) United States
(12) Patent Application Publication
(10) Pub. No.: US 2006/0050817 A1
(43) Pub. Date: Mar. 9, 2006

(54) Receiving apparatus and receiving method

(76) Inventors: Hideki Kanemoto, Yokosuka-shi (JP); Koichi Aihara, Yokosuka-shi (JP)

Correspondence Address: STEVENS, DAVIS, MILLER & MOSHER, LLP, 1615 L. STREET N.W., SUITE 850, WASHINGTON, DC, 20036, US

(21) Appl. No.: 10/542,603

(22) PCT Filed: Nov. 15, 2004
(86) PCT No.: PCT/JP04/16962

§ 371 Date: Jul. 18, 2005

(30) Foreign Application Priority Data
Nov. 21, 2003 (JP) 2003-393152

(51) Int. Cl. H04B 7/10; H04L 27/08

(52) U.S. Cl. 375/347; 375/345

(57) ABSTRACT

A reception apparatus that performs AGC processing on signals received in an antenna with a plurality of branches. In this apparatus, at the time a power calculation section (141) has completed calculation of a power value and an AGC gain calculation section (105) has completed gain calculation, an operation timing control section (108) instructs a power calculation section (142) to calculate a power value. Further, at the time the power calculation section (142) has completed calculation of the power value and the AGC gain calculation section (105) has completed the gain calculation, the operation timing control section (108) instructs the power calculation section (141) to calculate a power value.

### TECHNICAL FIELD

The present invention relates to a reception apparatus and reception method, and more particularly, to a reception apparatus and reception method suitable for use in diversity reception.

### BACKGROUND ART

In the case of performing reception diversity using a plurality of antennas in reception, in order to make full use of the reception diversity gain, it is necessary to operate AGC in amplification of a received signal for each antenna. In AGC processing, such processing is performed serially and periodically that calculates the reception power to calculate an AGC gain. Used conventionally to operate AGC for each antenna are a configuration (FIG.1) where an AGC processing section is provided for each antenna and operated independently, and another configuration (FIG.3) where part or the whole of the AGC processing is shared by all the antennas to operate in time division (for example, Patent Document 1).

FIG.1 is a block diagram showing an example of the conventional reception apparatus. FIG.1 illustrates a configuration where each antenna has an AGC processing section, and the hardware is twice as large as that in the case of one antenna.

In FIG. 1, radio reception section 12 amplifies a signal received in antenna 11, and performs frequency conversion on the signal to output to power calculation section 13 and selection combining section 19. Power calculation section 13 calculates the power of the received signal and outputs the calculated power value to AGC gain calculation section 14. From the power value calculated in power calculation section 13, AGC gain calculation section 14 calculates a gain such that a signal amplified in radio reception section 12 is maintained at a predetermined level, and outputs an instruction for amplifying a signal by the calculated gain to radio reception section 12.

radio reception section 16 amplifies a signal received in antenna 15, and performs frequency conversion on the signal to output to power calculation section 17 and selection combining section 19. Power calculation section 17 calculates the power of the received signal and outputs the calculated power value to AGC gain calculation section 18. From the power value calculated in power calculation section 17, AGC gain calculation section 18 calculates a gain such that a signal amplified in radio reception section 16 is maintained at a predetermined level, and outputs an instruction for amplifying a signal by the calculated gain to radio reception section 16.

Selection combining section 19 adjusts phases of signals amplified in radio reception sections 12 and 16 to be in phase, combines the signals, and outputs a combined signal to demodulation section 20. Demodulation section 20 demodulates the combined signal.

In reception apparatus as shown in FIG. 1, power calculation and AGC gain calculation is performed for each antenna. FIG. 2 is a diagram illustrating control timing in the conventional reception apparatus. In FIG. 2, power calculation and AGC gain calculation is performed for each of respective signals received in antennas 11 and 15 independently thereof.

A configuration is considered which has power calculation sections for each antenna, i.e. twice as many as in the case of one antenna, while the AGC calculation section is shared by the antennas, and thus reduces the circuitry. FIG. 3 is a block diagram illustrating the configuration of the conventional reception apparatus, where the same sections as in FIG. 1 are assigned the same reference numerals to omit specific descriptions thereof.

In FIG. 3, from the power value calculated in power calculation section 13, AGC gain calculation section 31 calculates a gain such that a signal amplified in radio reception section 12 is maintained at a predetermined level, and outputs an instruction for amplifying a signal by the calculated gain to radio reception section 12. Further, from the power value calculated in power calculation section 17, the section 31 calculates a gain such that a signal amplified in radio reception section 16 is maintained at a predetermined level, and outputs an instruction for amplifying a signal by the calculated gain to radio reception section 16. In addition, AGC gain calculation section 31 needs to increase the AGC gain calculation processing speed by two times to perform the processing corresponding to two antennas.

In the conventional configuration as shown in FIG. 1, the power calculation for each of antennas is performed at the same time (timing), and the gain calculation based on the obtained power is also performed at the same timing between the antennas. FIG. 4 is a diagram illustrating control timing in the conventional reception apparatus. FIG. 4 shows the control timing of the reception apparatus shown in FIG. 3. As shown in FIG. 4, since it is necessary to perform the gain calculation processing of two antennas within the same period of time as in the configuration of FIG. 1, the processing time of one antenna must be half, and the gain calculation section requires the two-times processing capability.

Thus, when part or the whole of the processing sections are shared with the same operation timing in the AGC processing of a plurality of antennas, it is necessary to provide the adequate processing capability to perform temporally concentrated processing, while the processing capability is not always necessary, and therefore, the efficiency deteriorates.

Meanwhile, if the processing capability is not increased, the AGC update period is made twice, and the processing for each antenna is performed in time division. FIG. 5 is a diagram illustrating control timing in the conventional reception apparatus (with the configuration of FIG. 3). FIG. 5 shows an example of the control timing in the case of not increasing the processing capability in the AGC gain calculation section. In this case, the AGC update period is extended as shown in FIG. 5, the response characteristic to variations in reception power deteriorates, and reception performance thus deteriorates.

Patent Document 1 Japanese Laid-Open Patent Publication 2001-186070

### DISCLOSURE OF INVENTION

### PROBLEMS TO BE SOLVED BY THE INVENTION

Thus, in the conventional apparatuses, when the AGC processing is performed for signals received in an antenna with a plurality of branches, there is a problem that an apparatus configuration increases in size or the reception performance deteriorates.

It is an object of the present invention to provide a reception apparatus and reception method enabling the AGC processing to be performed on signals received in an antenna with a plurality of branches in a small apparatus configuration without deterioration of reception performance.

### MEANS FOR SOLVING THE PROBLEM

A reception apparatus of the invention has a configuration provided with a plurality of antennas spaced at a predetermined interval or more, a radio receiver that amplifies signals received in the antennas, a reception power calculator that calculates reception power of a signal received in each of the antennas, an AGC gain calculator that calculates a gain such that amplified reception power is a predetermined value to instruct the radio receiver, a controller that instructs the AGC gain calculator to calculate a gain to amplify a received signal received in some of the antennas when the reception power calculator calculates reception power of a signal received in another one of the antennas, and a combiner that combines amplified signals received in the antennas.

In a reception method of the invention, radio signals are received in a plurality of antennas, with respect to the signals received in a plurality of antennas an AGC gain of one of the antennas is calculated when reception power of the other antenna is calculated, the signal received in each of the antennas is amplified by the calculated AGC gain, and the signals received in the antennas are selected and combined.

### ADVANTAGEOUS EFFECT OF THE INVENTION

As described above, according to the reception apparatus and reception method of the invention, with respect to signals received in a plurality of antennas, an AGC gain of one of the antennas is calculated when reception power of the other antenna is calculated, whereby the need is eliminated for performing the reception power calculation and AGC gain calculation at the same time for a plurality of received signals, and it is possible to perform the reception power calculation and AGC gain calculation for signals received in a plurality of antennas in a small apparatus configuration.

### BRIEF DESCRIPTION OF DRAWINGS

FIG. 1 is a block diagram showing an example of a conventional reception apparatus;

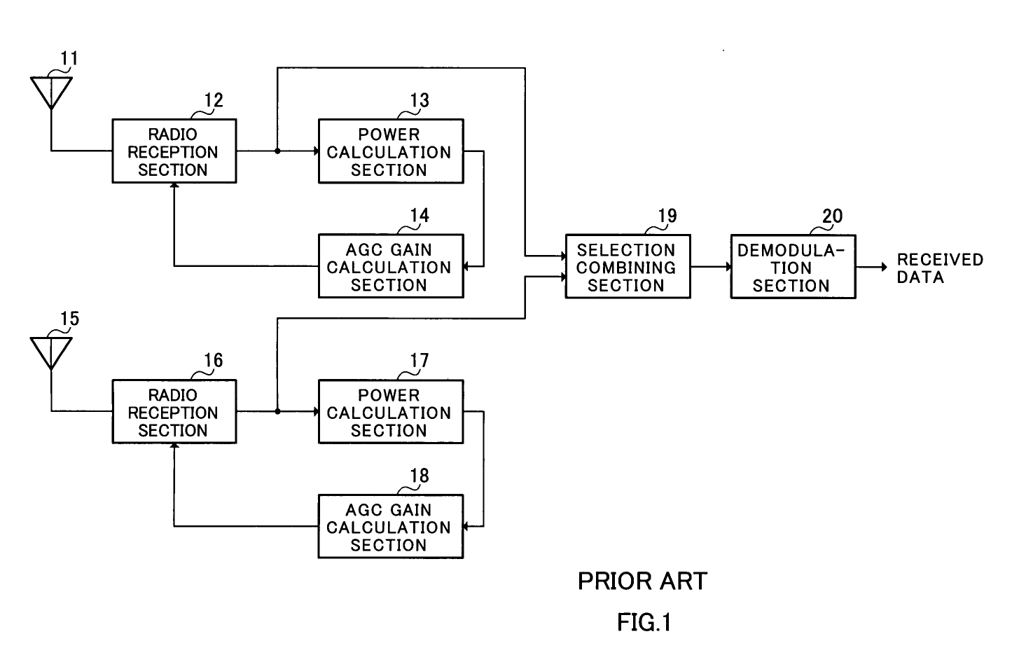

FIG. 2 is a diagram illustrating control timing in the conventional reception apparatus;

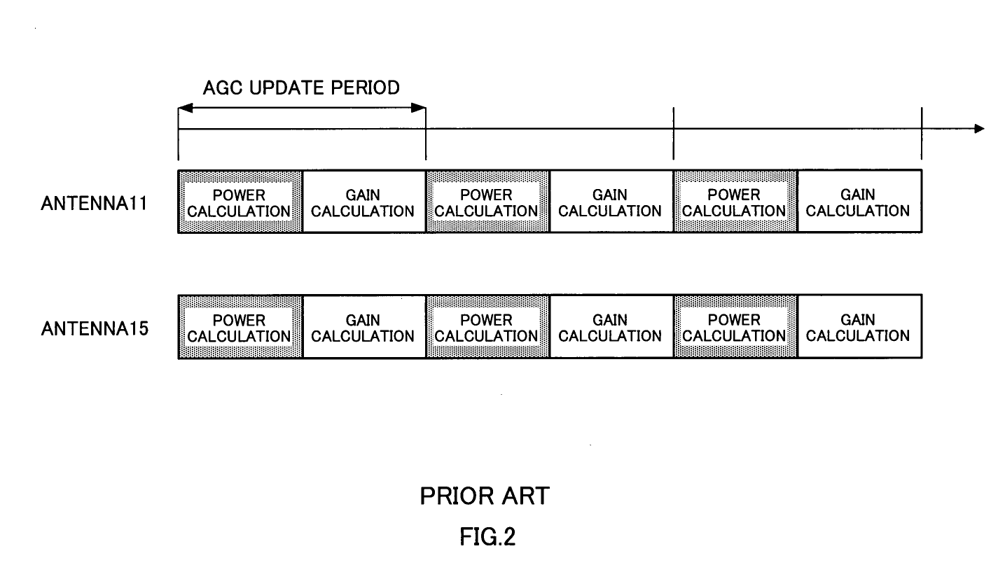

FIG. 3 is a block diagram showing another example of the conventional reception apparatus;

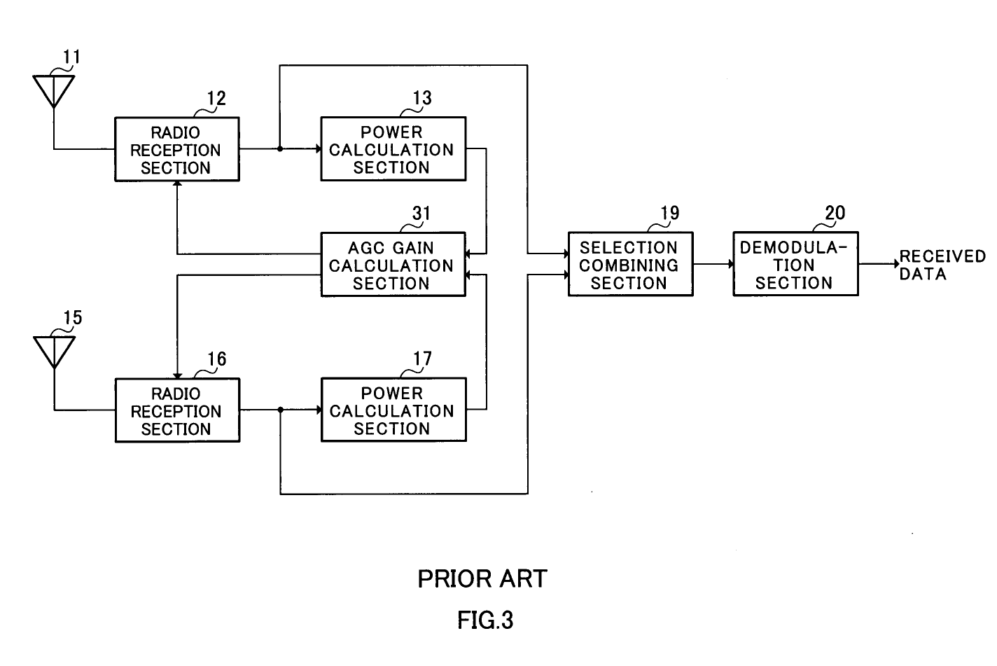

FIG. 4 is a diagram illustrating control timing in the conventional reception apparatus;

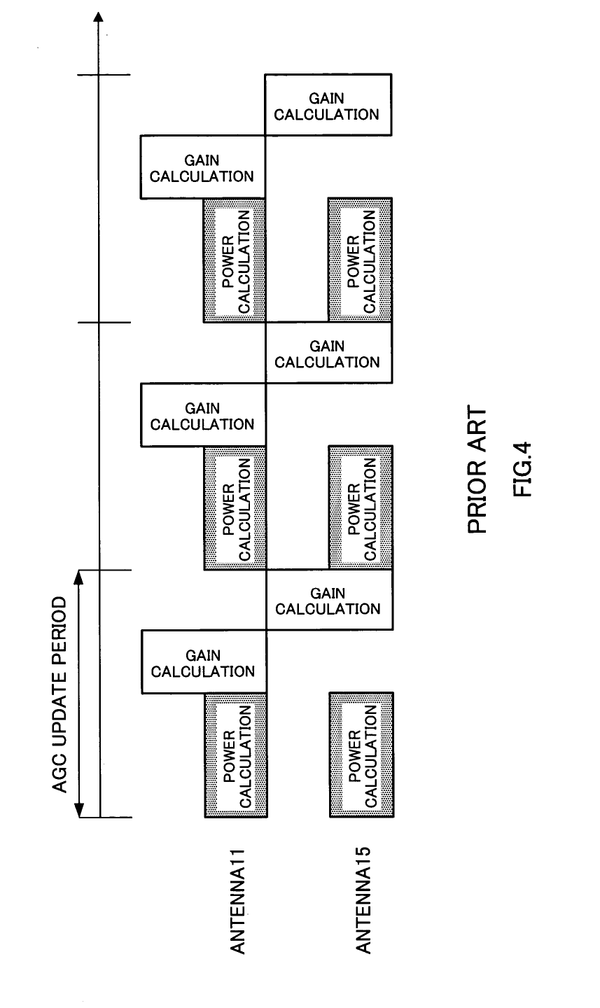

FIG. 5 is a diagram illustrating other control timing in the conventional reception apparatus;

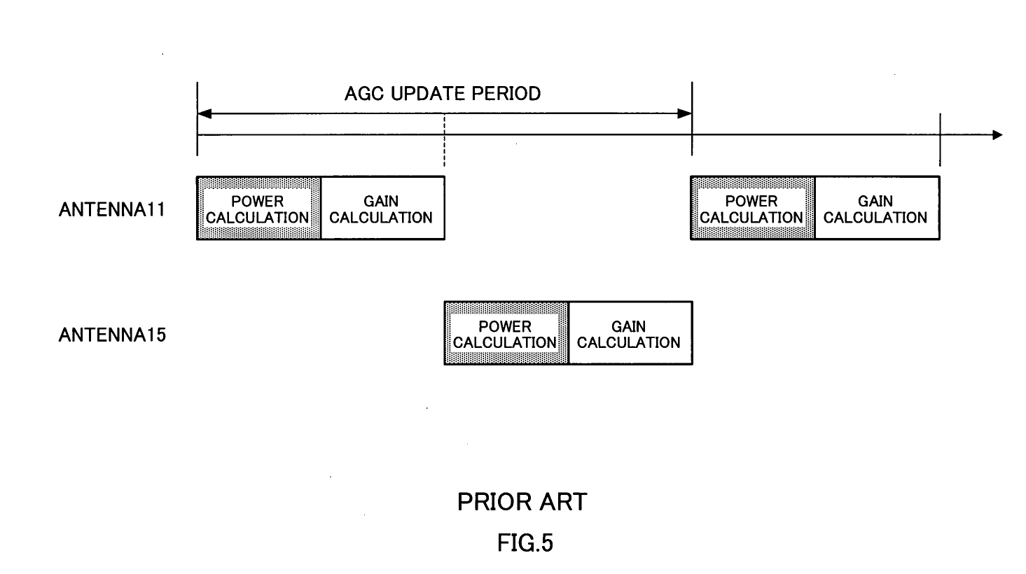

FIG. 6 is a block diagram illustrating a configuration of a reception apparatus according to Embodiment 1 of the present invention;

FIG. 7 is a diagram illustrating operation timing in the reception apparatus of the above Embodiment;

FIG. 8 is another diagram illustrating the operation timing in the reception apparatus of the above Embodiment;

FIG. 9 is a diagram illustrating other operation timing in the reception apparatus of the above Embodiment;

FIG. 10 is a block diagram illustrating a configuration of a reception apparatus according to Embodiment 2 of the present invention;

FIG. 11 is a block diagram illustrating a configuration of a reception apparatus according to Embodiment 3 of the present invention; and

FIG. 12 is a diagram illustrating operation timing in the reception apparatus of the above Embodiment.

### BEST MODE FOR CARRYING OF THE INVENTION

Embodiments of the present invention will specifically be described below with reference to accompanying drawings.

### Embodiment 1

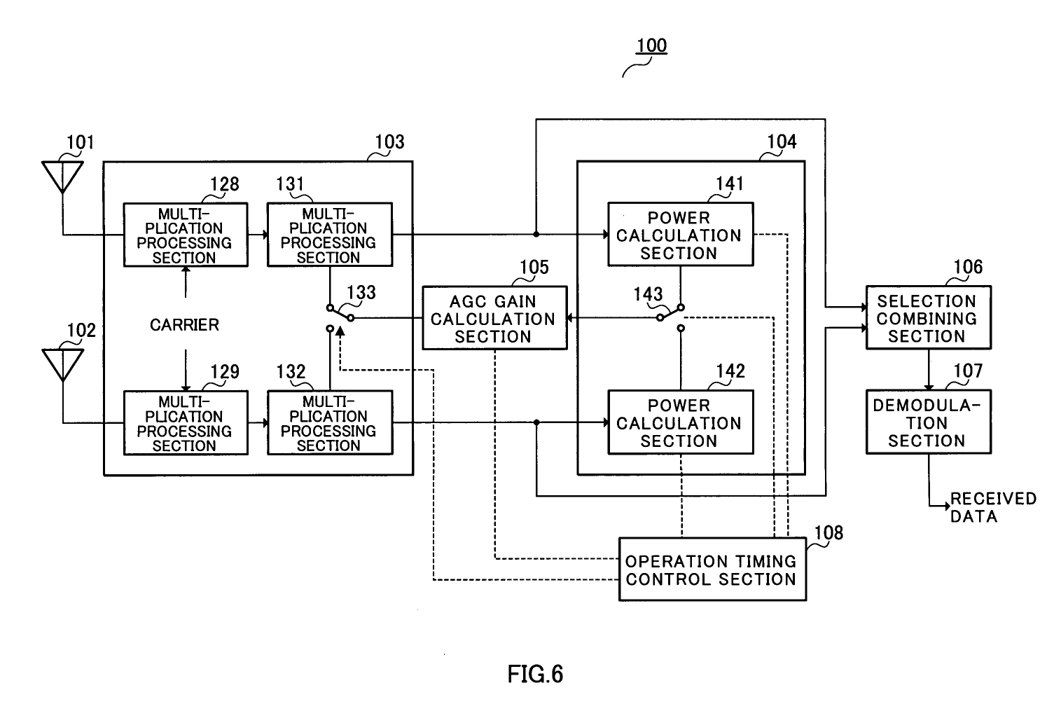

FIG. 6 is a block diagram illustrating a configuration of a reception apparatus according to Embodiment 1 of the present invention. Reception apparatus 100 as shown in FIG. 6 is principally comprised of antennas 101 and 102, radio reception section 103, reception power calculation section 104, AGC gain calculation section 105, selection combining section 106, demodulation section 107 and operation timing control section 108.

Radio reception section 103 is principally comprised of multiplication processing sections 128 and 129, filtering processing sections 131 and 132, and switching section 133. Reception power calculation section 104 is principally comprised of power calculation sections 141 and 142, and switching section 143.

In FIG. 6, antennas 1 and 2 are spaced a distance corresponding to the half-wavelength of a carrier or more. Multiplication processing section 128 multiplies a signal received in antenna 101 by the carrier to convert to a signal of the baseband frequency, and outputs the signal to filtering processing section 131. Filtering processing section 131 amplifies the signal subjected to frequency conversion in multiplication processing section 128 to output to power calculation section 141 and selection combining section 106. Similarly, multiplication processing section 129 multiplies a signal received in antenna 102 by the carrier to convert to a signal of the baseband frequency, and outputs the signal to filtering processing section 132. Filtering processing section 132 amplifies the signal subjected to frequency conversion in multiplication processing section 129 to output to power calculation section 142 and selection combining section 106.

Power calculation section 141 calculates power of the signal amplified in filtering processing section 131, and outputs the obtained power value to switching section 143. Similarly, power calculation section 142 calculates power of the signal amplified in filtering processing section 132, and outputs the obtained power value to switching section 143.

According to an instruction from operation timing control section 108, switching section 143 outputs the power value output from either power calculation section 141 or 142 to AGC gain calculation section 105.

From the power value output from either power calculation section 141 or 142, AGC gain calculation section 105 calculates a gain such that a signal amplified in filtering processing section 131 or 132 is maintained at a predetermined level, and outputs an instruction for amplifying a signal by the calculated gain to switching section 133.

According to an instruction from operation timing control section 108, switching section 133 outputs the calculated gain to filtering section 131 or 132.

At the time power calculation section 141 has completed the calculation of the power value and AGC gain calculation section 105 has completed the calculation of the gain based on the power value output from power calculation section 142, operation timing control section 108 instructs power calculation section 142 to calculate a power value, outputs an instruction to switching section 143 to output the power value calculated in power calculation section 141 to AGC gain calculation section 105, and further outputs an instruction to switching section 133 to output the gain calculated in AGC gain calculation section 105 to filtering processing 132.

Further, at the time power calculation section 142 has completed the calculation of the power value and AGC gain calculation section 105 has completed the calculation of the gain based on the power value output from power calculation section 141, operation timing control section 108 instructs power calculation section 141 to calculate a power value, outputs an instruction to switching section 143 to output the power value calculated in power calculation section 142 to AGC gain calculation section 105, and further outputs an instruction to switching section 133 to output the gain calculated in AGC gain calculation section 105 to filtering processing 131.

Selection combining section 106 selects and combines signals amplified in filtering processing sections 131 and 132 to output to demodulation section 107. Demodulation section 107 demodulates a combined selected signal to obtain received data.

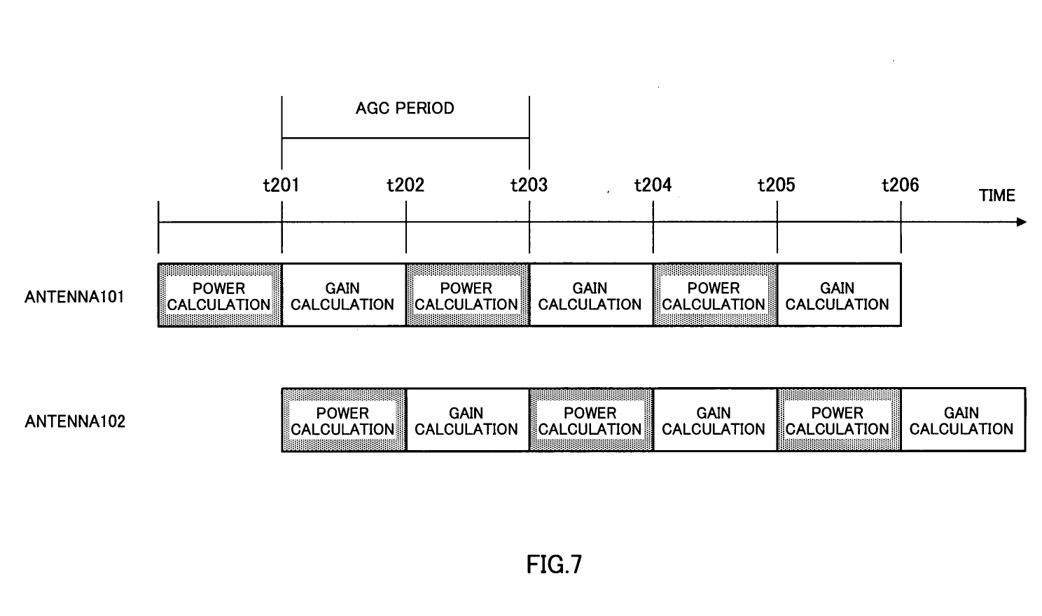

Described below is the operation of the reception apparatus according to this Embodiment. FIG. 7 is a diagram illustrating the operation timing in the reception apparatus of this Embodiment. In FIG. 7, during a period from time t201 to t202, AGC gain calculation section 105 calculates a AGC gain of a signal received in antenna 101, and power calculation section 142 calculates power of a signal received in antenna 102.

Then, during a period from time t202 to t203, AGC gain calculation section 105 calculates a AGC gain of a signal received in antenna 102, and power calculation section 141 calculates power of a signal received in antenna 101.

Similarly, during a period from time t203 to t204 and during a period from time t205 to t206, AGC gain calculation section 105 calculates a AGC gain of a signal received in antenna 101, and power calculation section 142 calculates power of a signal received in antenna 102.

Then, during a period from time t204 to t205, AGC gain calculation section 105 calculates a gain of AGC gain calculation section 105 of a signal received in antenna 102, and power calculation section 141 calculates power of a signal received in antenna 101.

Herein, one AGC period is a period from t201 to t203.

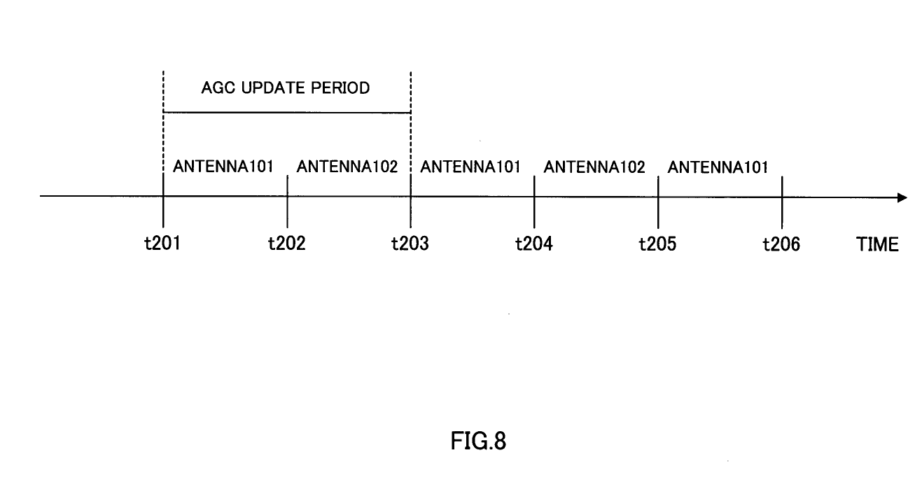

The power calculation and AGC gain calculation is carried out at timing as shown in FIG. 7, whereby the calculation is performed alternately for signals received in a plurality of antennas. FIG. 8 is another diagram illustrating the operation timing in the reception apparatus of this Embodiment.

As shown in FIG. 8, the AGC gain calculation of antenna 101 and the power calculation of antenna 102 is performed during periods from time t201 to t202, from t203 to t204 and from t205 to t206. The AGC gain calculation of antenna 102 and the power calculation of antenna 101 is performed during periods from time t202 to t203 and from t204 to t205.

Thus, according to the reception apparatus of this Embodiment, with respect to signals received in a plurality of antennas, an AGC gain of one of the antennas is calculated when reception power of the other antenna is calculated, whereby the need is eliminated for performing the reception power calculation and AGC gain calculation at the same time for a plurality of received signals, and it is possible to perform the reception power calculation and AGC gain calculation for signals received in a plurality of antennas in a small apparatus configuration.

In addition, described in the foregoing is the example where the reception power calculation and AGC gain calculation has the same processing time. The case is also applicable that the processing time of the reception power calculation is different from that of the AGC gain calculation. This case can be implanted by setting the time twice as long as the longer processing time as a period AGC update.

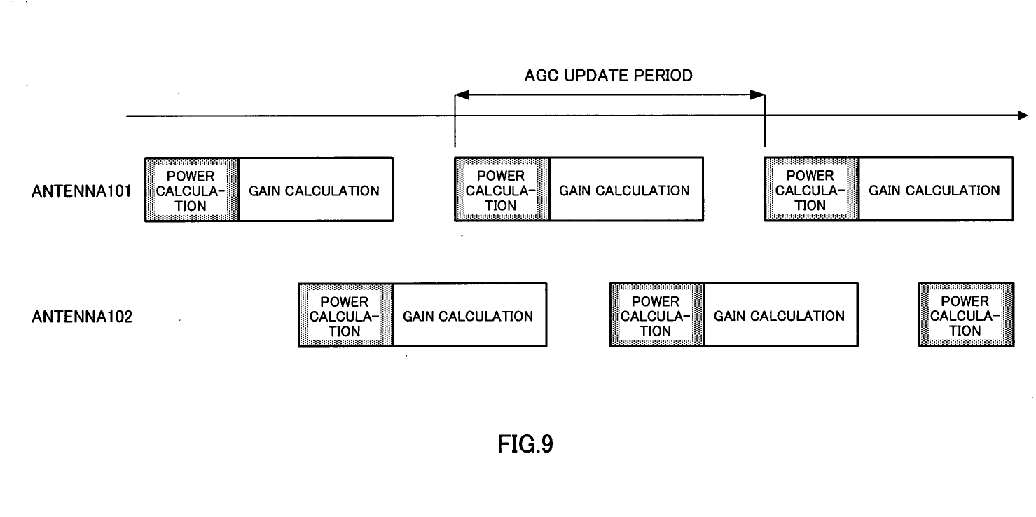

FIG. 9 is a diagram illustrating an other operation timing in the reception apparatus of this Embodiment. FIG. 9 shows an example where the processing time of the AGC gain calculation is longer than that of the reception power calculation. As shown in FIG. 9, by setting the time twice as long as the processing time of the AGC gain calculation as a period of AGC update, it is possible to execute each of the reception power calculation and AGC gain calculation in a single circuit alternately.

In FIG. 9 the AGC gain calculation is performed immediately after the power calculation is finished, but the invention is not limited thereto. The AGC gain calculation may be performed after a lapse of a predetermined time after the power calculation is finished. In this case, the power calculation can be performed at any timing if finished during a period of time the AGC gain calculation for another antenna is performed.

Further, the aforementioned Embodiment describes the case of receiving signals in two antennas, but the number of antennas is not limited particularly. In other words, in the case where power values and AGC gains are calculated for signals received in n antennas, it is possible to implement by setting the time n times the longer processing time as a period of AGC update.

### Embodiment 2

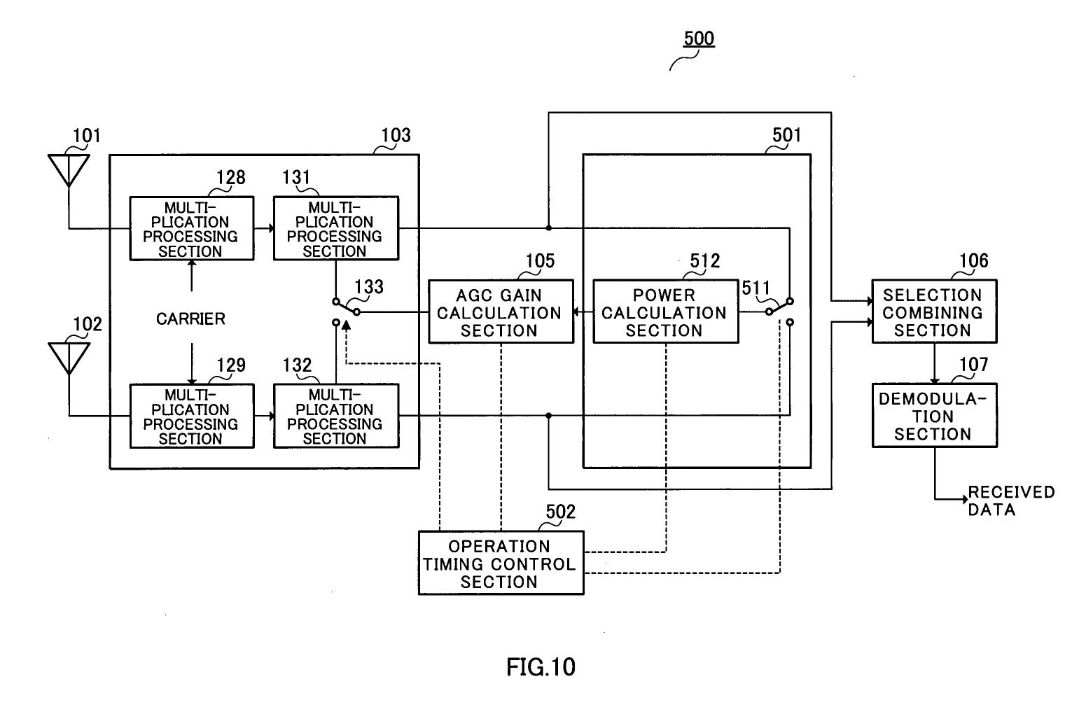

FIG. 10 is a block diagram illustrating a configuration of a reception apparatus according to Embodiment 2 of the present invention. In addition, the same sections as in FIG. 6 are assigned the same reference numerals to omit specific descriptions thereof.

Reception apparatus 500 in FIG. 10 has reception power calculation section 501 and operation timing control section 502, and in this respect, is different from the reception apparatus of FIG. 6. Reception power calculation section 501 is principally comprised of switching section 511 and power calculation section 512.

According to an instruction from operation timing control section 502, switching section 511 outputs a signal output from filtering section 131 or 132 to power calculation section 512.

Power calculation section 512 calculates power of the signal output from switching section 511, and outputs the obtained power value to AGC gain calculation section 105.

At the time power calculation section 512 has completed the calculation of the power value of a signal received in antenna 101 and AGC gain calculation section 105 has completed the calculation of the gain of a signal received in antenna 102, operation timing control section 502 instructs power calculation section 512 to calculate a power value of a signal received in antenna 102, further instructs AGC gain calculation section 105 to calculate the gain of a signal received in antenna 101, outputs an instruction to switching section 511 to output the signal amplified in filtering processing section 132 to power calculation section 512, and further outputs an instruction to switching section 133 to output the gain calculated in AGC gain calculation section 105 to filtering processing 132.

Meanwhile, at the time power calculation section 512 has completed the calculation of the power value of a signal received in antenna 102 and AGC gain calculation section 105 has completed the calculation of the gain of a signal received in antenna 101, operation timing control section 502 instructs power calculation section 512 to calculate a power value of a signal received in antenna 101, further instructs AGC gain calculation section 105 to calculate the gain of a signal received in antenna 102, outputs an instruction to switching section 511 to output the signal amplified in filtering processing section 131 to power calculation section 512, and further outputs an instruction to switching section 133 to output the gain calculated in AGC gain calculation section 105 to filtering processing 131.

Thus, according to the reception apparatus of this Embodiment, with respect to signals received in a plurality of antennas, an AGC gain of one of the antennas is calculated when reception power of the other antenna is calculated, whereby the need is eliminated for performing the reception power calculation and AGC gain calculation at the same time for a plurality of received signals, and it is possible to perform the reception power calculation and AGC gain calculation for signals received in a plurality of antennas in a small apparatus configuration.

### Embodiment 3

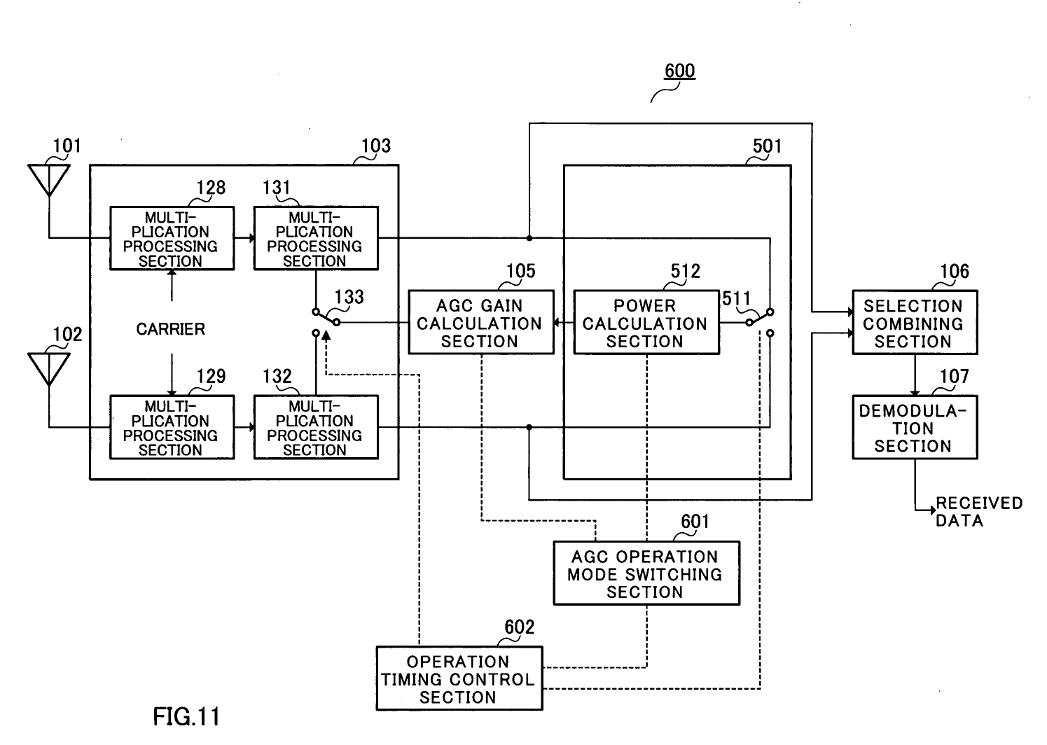

FIG. 11 is a block diagram illustrating a configuration of a reception apparatus according to Embodiment 3 of the present invention. In addition, the same sections as in FIG. 6 or FIG. 10 are assigned the same reference numerals to omit specific descriptions thereof.

Reception apparatus 600 in FIG. 11 has AGC operation mode switching section 601 and operation timing control section 602, calculates reception power of one antenna while calculating the AGC gain of the other antenna when the AGC update period is short, and in this respect, is different from the reception apparatus in FIG. 6.

AGC operation mode switching section 601 notifies operation timing control section 602 of whether there is a mode where an AGC update period in an initial state such as synchronization acquisition is shorter than that in an ordinary reception state and of whether the AGC update period is longer in the ordinary reception state.

When the AGC update period in the initial state such as synchronization acquisition is shorter than that in the ordinary reception state, at the time power calculation section 512 has completed the calculation of a power value of a signal received in antenna 101 and AGC gain calculation section 105 has completed the calculation of the gain of a signal received in antenna 102, AGC operation mode switching section 601 instructs power calculation section 512 to calculate a power value of a signal received in antenna 102, and further instructs AGC gain calculation section 105 to calculate the gain of a signal received in antenna 101.

Further, when the AGC update period in the initial state such as synchronization acquisition is shorter than that in the ordinary reception state, at the time power calculation section 512 has completed the calculation of a power value of a signal received in antenna 102 and AGC gain calculation section 105 has completed the calculation of the gain of a signal received in antenna 101, AGC operation mode switching section 601 instructs power calculation section 512 to calculate a power value of a signal received in antenna 101, and further instructs AGC gain calculation section 105 to calculate the gain of a signal received in antenna 102.

When the AGC update period in the initial state such as synchronization acquisition is shorter than that in the ordinary reception state, at the time power calculation section 512 has completed the calculation of a power value of a signal received in antenna 101 and AGC gain calculation section 105 has completed the calculation of the gain of a signal received in antenna 102, operation timing control section 602 outputs an instruction to switching section 511 to output the signal amplified in filtering processing section 132 to power calculation section 512, and further outputs an instruction to switching section 133 to output the gain calculated in AGC gain calculation section 105 to filtering processing 132.

Further, when the AGC update period in the initial state such as synchronization acquisition is shorter than that in the ordinary reception state, at the time power calculation section 512 has completed the calculation of a power value of a signal received in antenna 102 and AGC gain calculation section 105 has completed the calculation of the gain of a signal received in antenna 101, operation timing control section 602 outputs an instruction to switching section 511 to output the signal amplified in filtering processing section 132 to power calculation section 512, and further outputs an instruction to switching section 133 to output the gain calculated in AGC gain calculation section 105 to filtering processing 131.

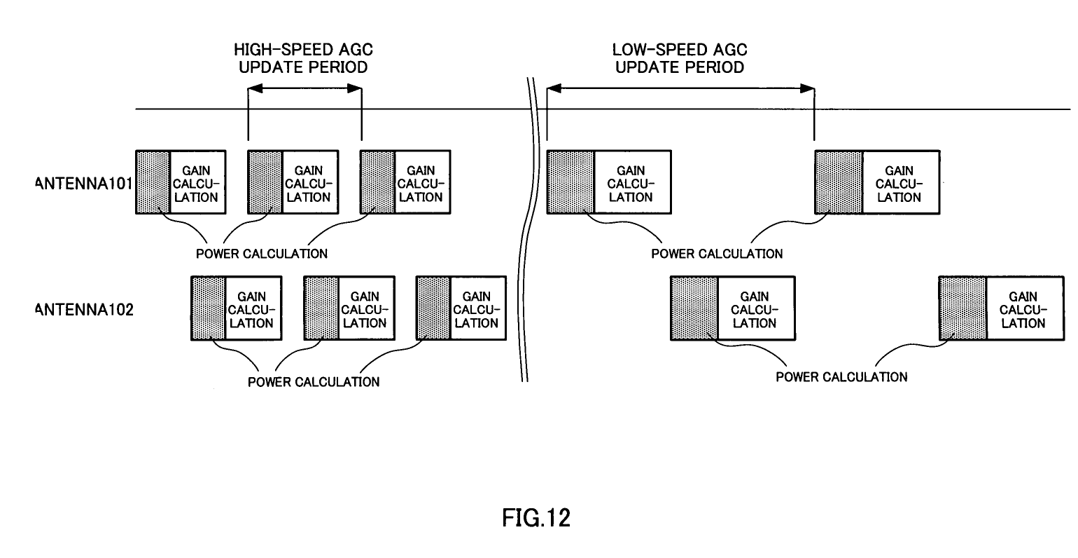

Described below is the operation of the reception apparatus according to this Embodiment. FIG. 12 is a diagram illustrating the operation timing in the reception apparatus of this Embodiment.

As shown in FIG. 12, when the AGC update period is less than twice the processing time of the power calculation and gain calculation, the reception power of one antenna is calculated, while the AGC gain of the other antenna is calculated. Further, when the AGC update period is more than twice the processing time of the power calculation and gain calculation, ordinary reception power calculation and AGC gain calculation is performed.

Further, the aforementioned Embodiment describes the case of receiving signals in two antennas, but the number of antennas is not limited particularly. In other words, in the case where power values and AGC gains are calculated for signals received in n antennas, when the AGC update period is less than n times the processing time of the power calculation and gain calculation, the reception power of one antenna is calculated, while the AGC gain of the other antenna is calculated. Further, when the AGC update period is more than n times the processing time of the power calculation and gain calculation, ordinary reception power calculation and AGC gain calculation is performed.

Herein, the power calculation in high-speed AGC may not be the same as the power calculation in low-speed AGC. Similarly, the gain calculation may not be the same.

Thus, according to the reception apparatus of this Embodiment, when the AGC update period is shorter than that in the ordinary reception state, with respect to signals received in a plurality of antennas, the reception power of one antenna is calculated, while the AGC gain of the other antenna is calculated, whereby the need is eliminated for performing the reception power calculation and AGC gain calculation at the same time for a plurality of received signals, and it is possible to perform the reception power calculation and AGC gain calculation for signals received in a plurality of antennas in a small apparatus configuration.

In addition, the present invention is not limited to the above-mentioned Embodiments, and is capable of being carried into practice with various modifications thereof. For example, the above-mentioned Embodiments describe the case where the invention is implemented as a reception apparatus, but the invention is not limited thereto, and the reception method is capable of being implemented as software.

For example, it may be possible that a program to execute the above-mentioned reception method is stored beforehand in ROM (Read Only Memory), and the program is operated by a CPU (Central Processor Unit).

Further, it may be possible that a program to execute the above-mentioned reception method is stored in a computer readable storage medium, the program stored in the storage medium is stored in RAM (Random Access Memory) of a computer, and the computer is operated according to the program.

The present application is base don Japanese Patent Application No. 2003-393152 filed on Nov. 21, 2003, entire content of which is expressly incorporated by reference herein.

### INDUSTRIAL APPLICABILITY

The present invention is suitable for use in a reception apparatus and communication apparatus that perform reception diversity.

1. A reception apparatus comprising:
a plurality of antennas spaced at a predetermined interval or more;
a radio receiver that amplifies signals received in the antennas;
a reception power calculator that calculates reception power of a signal received in each of the antennas;
an AGC gain calculator that calculates a gain such that amplified reception power is a predetermined value to instruct to the radio receiver;
a controller that instructs the AGC gain calculator to calculate a gain to amplify a received signal received in some of the antennas, when the reception power calculator calculates reception power of a signal received in another one of the antennas; and
a combiner that combines amplified signals received in the antennas.

2. The reception apparatus according to claim 1, wherein the radio receiver comprises a plurality of amplifiers that amplifies a signal received for each of the antennas, and a first switch that outputs an instruction output from the AGC gain calculator to either of the amplifiers, the reception power calculator comprises a plurality of power calculators that calculates a power value of a signal received corresponding to each of the antennas, and a second switch that outputs a power value of one of the power calculators that has completed calculation of the power value to the AGC gain calculator, and the controller instructs the second switch to output to the AGC gain calculator a power value output from either of the power calculators corresponding to one of the antennas targeted for AGC calculation, and further instructs the first switch to output the instruction output from the AGC gain calculator to corresponding one of the amplifiers.

3. The reception apparatus according to claim 1, wherein the radio receiver comprises a plurality of amplifiers that amplifies a signal received for each of the antennas, a first switch that outputs an instruction output from the AGC gain calculator to either of the amplifiers, and a third switch that selects a signal output from one of the amplifiers corresponding to one of the antennas targeted for calculation of a power value, the reception power calculator calculates the power value of the signal selected in the third switch, and the controller instructs the first switch to output an instruction output from the AGC gain calculator to corresponding one of the amplifiers, and further instructs the third switch to select a signal output from one of the amplifiers corresponding to one of the antennas targeted for calculation of a power value.

4. The reception apparatus according to claim 1, further comprising:
an AGC operation mode switch that instructs an AGC update period,
wherein the AGC gain calculator notifies the controller of whether the AGC update period is less than or more than the time obtained by multiplying processing time of power calculation and gain calculation by the number of antennas, and when the AGC update period is less than the time obtained by multiplying the processing time of the power calculation and the gain calculation, the controller instructs the AGC gain calculator to calculate a gain to multiply a received signal received in some of the antennas, at the time the reception power calculator calculates reception power of a signal received in another one of antennas.

5. A reception method wherein radio signals are received in a plurality of antennas, with respect to the signals received in the plurality of antennas an AGC gain of one of the antennas is calculated when reception power of the other antenna is calculated, the signal received in each of the antennas is amplified by the calculated AGC gain, and the signals received in the antennas are selected and combined.
